(19) United States
(12) Patent Application Publication
(10) Pub. No.: US 2004/0214493 A1
(43) Pub. Date: Oct. 28, 2004

(54) Printable synthetic fabric

(76) Inventor: Garnett H. Smith, Gastonia, NC (US)

Correspondence Address: WOMBLE CARLYLE SANDRIDGE & RICE PLLC, 300 N. GREENE STREET, SUITE 1900, GREENSBORO, NC, 27401, US

(21) Appl. No.: 10/853,968

(22) Filed: May 26, 2004

Related U.S. Application Data
(63) Continuation-in-part of application No. 09/941,124, filed on Aug. 28, 2001, now Pat. No. 6,759,354.

(51) Int. Cl. B32B 5/02; B32B 27/04; B32B 27/12; B32B 27/02; D04B 1/00; D04B 7/00; D04B 9/00; D04B 11/00; D04B 21/00; D06P 5/15

(52) U.S. Cl. 442/118; 442/170; 442/304

(57) ABSTRACT

A printed fabric with high dye penetration, high dye fixation, and a soft hand, formed by a process comprising printing disperse dyes on a synthetic-rich fabric, the synthetic-rich fabric having been pre-treated with a wicking agent. The finished dyed knitted fabric has a dry crocking index of at least 4.0 and a soft hand.

### RELATED APPLICATIONS

This is a continuation-in-part of application Ser. No. 09/941,124, filed Aug. 28, 2001, now pending, the content of which is incorporated herein in its entirety.

### FIELD OF THE INVENTION

The present invention relates generally to fabrics receptive to printing or dyeing, and, more particularly, to a synthetic-rich fabric with an improved propensity for dye penetration, dye fixation, and a soft hand.

### BACKGROUND OF THE INVENTION

Dyeing has been a part of the finishing process for textiles for thousands of years. For both aesthetic and practical reasons, fabrics and apparel crafted therefrom have been subjected to bleaching and coloring processes.

There are a number of dyeing processes currently in practice, depending upon the particular yarns forming the knitted, woven, or non-woven fabrics. For instance, the natural and man-made fibers and filaments have differing affinities for dyestuffs. Further, fabrics may be piece dyed, tie dyed, cross-dyed, or printed. Printing types include conventional roller printing, flat screen, rotary screen printing, digital printing, and heat transfer (sublimation) printing.

As a general rule, the printing of fabrics made from man-made (synthetic) fibers or filaments has been problematic. Synthetic yarns tend to be hydrophobic and therefore hard to print with pigments, as pigments do not penetrate the yarn, but rather are affixed to the surface of the fabric. Synthetic fabrics such as polyester, nylon, and others are dyestuff-specific and will not accept all categories of dyestuffs.

Heat transfer printing with disperse dyes has been the technique generally found acceptable for synthetics and produces a well-defined pattern on the face of the fabric; however, this type of printing requires that disperse dyes be first applied to a paper substrate and then heat transferred to a fabric surface. While the outer printed surface has a satisfactory appearance and sharpness of lines, the disperse dyes do not completely penetrate the yarns forming the fabric. This results in an undyed inner surface and an unacceptable dyed appearance when the fabric is stretched, due to lack of dye penetration between yarns.

Applying dyes directly to a fabric has been attempted; however, heretofore the resulting product has not had the soft hand, level of crocking, or the high level of colorfastness of disperse dyes applied by the heat transfer method. Further, the disperse dyes have not been compatible with conventional softeners. This is the problem addressed by the present invention; that is, how to obtain a better dye result with disperse dyes applied directly to synthetics.

The intended use of an item of apparel dictates the combination of yarn, fabric construction (woven, knitted, etc.), finishing, and dyeing that goes into the item. For example, important characteristics of many items of apparel include softness, firmness, fineness, or other qualities perceived by touch, colorfastness, and the ability of the material to disperse or spread moisture, or wicking. Of the various characteristics, softness is often the most desired quality in apparel. To achieve this quality, particularly in synthetic fabrics, chemical finishes such as softeners are used. Unfortunately, conventional softeners are hydrophobic, thus lacking an affinity to absorb water, or dyes. This has been particularly problematic where disperse dyes have been used.

### SUMMARY OF THE INVENTION

The present invention is directed to a synthetic-rich fabric and apparel formed therefrom that has improved dye penetration, colorfastness, and a soft hand not heretofore known in synthetic-rich fabrics where the dye is applied directly to the fabric.

In the preferred embodiment of the present invention, a knitted fabric is formed from 100 percent polyester yarn, although other synthetic-rich yarns are equally suitable.

As used herein, “synthetic-rich” means that at least 51% of the yarn is polyester or other suitable synthetic material and 49% or less of the yarn is natural.

Any conventional fabric construction may be printed with the present invention, but the preferred embodiment is a knit construction. The knit construction may be single knit, double knit, etc. and there is no limitation on the type of knitting machine that may be used to form the initial, or greige, knitted fabric. Further, yarns sizes are not critical to the present invention, but spun fibers of polyester in counts of 10/1 to 40/1 have been found most suitable. Alternatively, continuous filaments could be used to form yarn constructions having composite deniers between about 40 and 300.

The fabric is initially chemically treated with a wicking agent and heat set. In addition to being hydrophilic, which aids substantially in the penetration of disperse dyes applied directly to the fabric, the wicking agent used herein produces a secondary benefit of creating some softening in the fabric. Additionally, a hydrophilic softener may be applied to the knitted fabric. Heretofore, softeners have not been used for printed synthetic fabrics because of their hydrophobic characteristics which impede dye fixation, particularly with disperse dyes.

Once chemically treated with the wicking agent (and hydrophilic softener as desired), the treated fabric is ready for the printing process. In the preferred embodiment, rotary screen printing is used, but other direct printing processes such as screen printing or roller printing could also be used. With the rotary screen printing machine, one or more disperse dyes are used to obtain the desired color pattern. Disperse dyes are a class of water-soluble dyes usually applied from aqueous solutions and known for dyeing synthetic fibers, although only heat transfer printing heretofore has yielded satisfactory results. In the present invention, the dyestuffs are suspended using a commercially available concentrate and applied directly to the fabric by the rotating screens. Alternatively, as described in greater detail below, a high-energy dyestuff may be used to print the fabric.

Following printing, the printed fabric is subjected to a fixation process. As described in greater detail below, there are a number of methods for fixing the dye with heat, including but not limited to, exposure to forced-air, exposure to steam, and infrared heating.

Once the printed fabric has been heat set, the final product is complete and ready for packaging. It has been found that the combination of disperse dyes and a wicking agent, when applied to a synthetic-rich, e.g., 51 percent to 100 percent knitted polyester fabric, produces unexpected results in the final fabric. That is, the final fabric exhibits both a dry and wet crock of at least 4.0. Additionally, the colorfastness of the finished dyed fabric is excellent, measuring 4 when subjected to the American Association of Textile Chemists and Colorists (AATCC) Test Method 61-1996, “Colorfastness to Laundering, Home and Commercial: Accelerated”, which measures colorfastness on a scale of 1 to 5. The final fabric also has a soft hand. As used herein, “hand” refers to that characteristic widely known in the textile industry as the tactile quality of a fabric; e.g., softness, firmness, elasticity, fineness, resiliency, and other qualities perceived by touch. Thus, the final fabric of the present invention exhibits a soft, as opposed to a rough or stiff, hand.

These and other aspects of the present invention will become apparent to those skilled in the art after a reading of the following description of the preferred embodiment when considered with the drawings.

### BRIEF DESCRIPTION OF THE DRAWINGS

FIG. 1 is a simplified flow diagram of the process for making the printable knitted fabric of the present invention.

### DESCRIPTION OF THE PREFERRED EMBODIMENTS

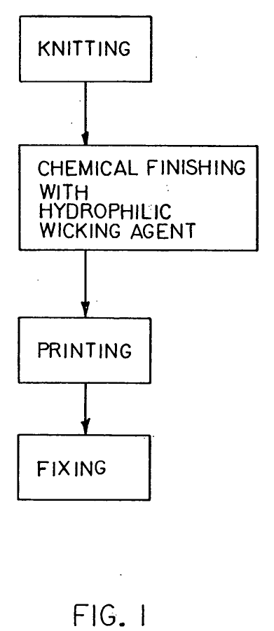

Referring now to FIG. 1, it will be understood that the illustration is for the purpose of describing a preferred embodiment of the invention and is not intended to limit the invention thereto. FIG. 1 is a simplified flow diagram of the process for making the printed fabric of the present invention.

In a preferred embodiment, a 100 percent polyester fabric is used to form the final printed fabric; however, a synthetic-rich, e.g., at least 51 percent synthetic material, also yields suitable results. Preferably, yarn counts between 10/1 and 40/1 are used in the knitting process. The yarn is formed from staple fibers that may be air jet spun, ring spun, open end spun, or any combination of these. Alternatively, continuous filament yarn constructions may be used. The fabric may also be formed in any knit construction on either single knit or double knit machines. Alternatively, the fabric may be a woven or non-woven construction.

The fabric is first chemically finished with a hydrophilic wicking agent to give the finished fabric the ability to disperse or spread moisture. One suitable wicking agent is known as Hydrowick HP®, available from Hydrotex of Raleigh, N.C. It has also been found that this wicking agent imparts some degree of softness to the finished fabric. Because the wicking agent itself is hydrophilic, it conditions the fabric to be substantially more receptive to disperse dyes applied/printed directly to the fabric. When additional softness of hand is desired, a softener is optionally applied to the pre-dyed fabric. Heretofore, softeners have not been used in conjunction with printing because they interfere with the dye fixing to the fabric. This is because softeners have conventionally been hydrophobic, which has been an impediment to dye penetration. Softeners are now known having hydrophilic qualities that not only produce a soft hand, but also help make the fabric more receptive to disperse dyes applied or printed directly to the fabric. While several hydrophilic softeners are now available, one softener that provides exceptional results is available as C-Soft WS, manufactured by Caldwell Chemicals of Mint Hill, N.C. Depending upon the particular fabric construction, the treated, unprinted fabric is heatset at a temperature of between about 250 and 380 degrees Fahrenheit for between about 30 and 60 seconds. The fabric is then ready for printing.

In a preferred embodiment, the printing is performed on a rotary screen printing machine, but may also be screen printed or rolled in conventional fashion, etc. The rotary printing machine used to produce the printed fabric is manufactured by Zimmer of Kufstein, Austria. With rotary screen printers, ink is forced from within the roller (screen) through apertures that form a pattern on the roller. Either a single color or multiple colors of disperse dyes are used. A line of suitable disperse dyes, available from BASF of Lugwigshafen, Germany, include Bafixan Pink FF3B, Bafixan Yellow 3GE, Bafixan Blue 2RL, Bafixan Blue RS, and Bafixan Black BN. While the Bafixan line has other dyestuffs for both polyester and nylon, those listed herein are the ones found most suitable for simple heat fixation. Thus, the present invention is not limited to these particular dyestuffs, but rather to disperse dyestuffs suitable for heat fixation on synthetic materials such as polyester and nylon. The dyestuffs are suspended using a concentrate known as Lutexol HIT, also available from BASF of Lugwigshafen, Germany.

The use of these disperse dyes, in combination with a hydrophilic wicking agent, facilitates excellent dye penetration throughout the fabric so that both sides of the fabric sheet are evenly printed, yet retaining a soft hand. This is superior to heat transfer printing where only one side of the fabric is printed, and far exceeds the finished characteristics of fabric that is printed with pigments.

Alternatively, as described in greater detail below, a high-energy dyestuff may be used to print the fabric. As used herein, “high-energy” dyestuffs refers to dyestuffs having a molecular makeup which requires higher energy levels, i.e., higher temperatures and longer exposure times for the dyes to sublimate and fix themselves to the fabric. While there are numerous sources for high-energy dyestuffs, one found suitable for the present invention is available from Ciba as the Terasil product line. Another available from FibroChem is Fibril 1601.

During the printing process, the high energy dyes typically are printed on the fabric at about 20 yards per minute. The printed fabric is then dried in a print dryer at about 190 degrees Celcius for about 2 minutes.

After the disperse dyes have been applied and dried, the dyes are fixed to the fabric by the application of heat. While there are a number of ways that the disperse dyes can be fixed, the following are exemplary of several suitable fixation techniques. The choice of technique is dependent upon a number of factors, including polyester fiber type, print coverage, end use, and cost.

### EXAMPLE ONE

The printed fabric is passed through a tenter frame where it is stretched to the desired width with steam. To complete the fixation of the dye, the fabric is then subjected to propane gas heating at about 350 degrees Fahrenheit for between about 1.5 and 2 minutes.

### EXAMPLE TWO

The printed fabric is stretched to the desired width and passed through a forced-air heater where the temperature is between about 350 degrees Fahrenheit and 375 degrees Fahrenheit. With this method of drying, the required temperature is dependent on the velocity of the forced air; i.e., the slower the velocity of the air, the higher the temperature that is required, and the faster the velocity of the air, the lower the temperature that is required. In either case, however, the fabric itself must reach a temperature of between about 350 degrees Fahrenheit and 360 degrees Fahrenheit for the reaction/fixation to occur with this fixation technique. The required dwell time for fabric within this temperature range is approximately 2 minutes. As those skilled in the art will appreciate, the higher the temperature, the shorter the required dwell time.

### EXAMPLE THREE

The printed fabric is passed through an infra-red dryer where it is exposed to temperatures of between about 350 degrees Fahrenheit and 380 degrees Fahrenheit. The dwell time will vary with the length of the infra-red dryer, but will be between about 1.0 and 1.5 minutes. Again, the fabric itself must reach a temperature of between about 350 degrees Fahrenheit and 360 degrees Fahrenheit for the reaction/fixation to occur with this fixation technique.

### EXAMPLE FOUR

The wet fabric is introduced to steam at a temperature of between about 320 degrees Fahrenheit and 330 degrees Fahrenheit for approximately 10 minutes.

### EXAMPLE FIVE

Where a high-energy dyestuff has been used to print the fabric, the wet fabric is introduced to steam at a temperature of between about 360 degrees Fahrenheit and 370 degrees Fahrenheit for approximately 30 minutes; however, the required dwell time is dependent upon the selected temperature.

A benefit of the fixation process with disperse dyes is that auxiliary or supplemental binders and cross-linking agents are not required to achieve the desired level of fixation as compared to pigments. As those skilled in the art will appreciate, other fixation techniques will also produce satisfactory results.

The finished fabric has been tested and found to have a soft hand and a crocking index of at least 4.0 on both the wet and dry index. Additionally, after 100 washings, only minimal color loss is detected. The colorfastness of the finished dyed fabric is 4.0 (excellent) as measured by the American Association of Textile Chemists and Colorists (AATCC) Test Method 61-1996, “Colorfastness to Laundering, Home and Commercial: Accelerated”, which measures colorfastness on a scale of 1 to 5. This test method evaluates color loss resulting from detergent solutions and abrasive action of five typical hand, home or commercial launderings. By way of comparison, the colorfastness of pigments is only about 1 to 2.

Certain modifications and improvements will occur to those skilled in the art upon a reading of the foregoing description. It should be understood that all such modifications and improvements have been deleted herein for the sake of conciseness and readability but are properly within the scope of the following claims.

We claim:

1. A printed fabric with high dye penetration, high dye fixation, and a soft hand, formed by a process comprising:
(a) printing disperse dyes directly on a synthetic-rich fabric, the synthetic-rich fabric having been pre-treated with a wicking agent; and
(b) fixing the disperse dyes to the fabric by heating the fabric until the fabric reaches a temperature of between about 350 degrees Fahrenheit and 380 degrees Fahrenheit and maintain the temperature for between about 1 minute and 2 minutes, wherein the finished dyed knitted fabric has a dry crocking index of at least 4.0 and a soft hand.

2. The fabric of claim 1 wherein the fabric construction is knitted.

3. The fabric of claim 1 wherein said synthetic-rich fabric contains at least 51% polyester.

4. The fabric of claim 1 wherein the disperse dyes are directly applied by a process selected from the group of processes consisting of rotary screen printing, flat screen printing, and roller printing.

5. The fabric of claim 1 wherein the disperse dye is fixed to the fabric by exposing the fabric to forced-air having a temperature between about 350 and 375 degrees Fahrenheit.

6. The fabric of claim 1 wherein the disperse dye is fixed to the fabric by exposing the fabric to infrared heating at a temperature of between about 350 and 360 degrees Fahrenheit.

7. The fabric of claim 1 wherein the finished dyed fabric has a wet crocking index of at least 4.0.

8. The fabric of claim 1 wherein the colorfastness of the finished dyed fabric is 4.0 as measured by the AATCC 61-1996 test method.

9. A printed fabric with high dye penetration, high dye fixation, and a soft hand, formed by a process comprising:
(a) printing disperse dyes on a synthetic-rich fabric, the synthetic-rich fabric having been pre-treated with a wicking agent; and
(b) fixing the disperse dyes to the fabric by heating the fabric at a temperature of between about 320 degrees Fahrenheit and 375 degrees Fahrenheit for between about 2 minutes and 10 minutes, wherein the finished dyed fabric has a dry crocking index of at least 4.0 and a soft hand.

10. The fabric of claim 9 wherein the fabric construction is knitted.

11. The fabric of claim 9 wherein said synthetic-rich fabric contains at least 51% polyester.

12. The fabric of claim 9 wherein the disperse dyes are applied by a process selected from the group of processes consisting of rotary screen printing, flat screen printing, and roller printing.

13. The fabric of claim 9 wherein the finished dyed fabric has a wet crocking index of at least 4.0.

14. The fabric of claim 9 wherein the colorfastness of the finished dyed fabric is 4.0 as measured by the AATCC 61-1996 test method.

15. A garment made of a fabric construction that has a high degree of colorfastness and a soft hand, said fabric construction formed by a process comprising:
(a) printing disperse dyes directly on a synthetic-rich fabric, the synthetic-rich fabric having been pre-treated with a wicking agent; and
(b) fixing the disperse dyes to the fabric by heating the fabric until the fabric reaches a temperature of between about 350 degrees Fahrenheit and 380 degrees Fahrenheit and maintain the temperature for between about 1 minute and 2 minutes, wherein the finished dyed knitted fabric has a dry crocking index of at least 4.0 and a soft hand.

16. The garment of claim 15 wherein the fabric construction is knitted.

17. The garment of claim 15 wherein said synthetic-rich fabric contains at least 51% polyester.

18. The garment of claim 15 wherein the disperse dyes are applied by a process selected from the group of processes consisting of rotary screen printing, flat screen printing, and roller printing.

19. The garment of claim 15 wherein the disperse dye is fixed to the fabric by exposing the fabric to forced-air having a temperature between about 350 and 375 degrees Fahrenheit.

20. The garment of claim 15 wherein the disperse dye is fixed to the fabric by exposing the fabric to infrared heating at a temperature of between about 350 and 360 degrees Fahrenheit.

21. The garment of claim 15 wherein the finished dyed fabric has a wet crocking index of at least 4.0.

22. The fabric of claim 15 wherein the colorfastness of the finished dyed fabric is 4.0 as measured by the AATCC 61-1996 test method.

23. A garment made of a fabric construction that has a high degree of colorfastness and a soft hand, said fabric construction formed by a process comprising:
(a) printing disperse dyes on a synthetic-rich fabric, the synthetic-rich fabric having been pre-treated with a wicking agent; and
(b) fixing the disperse dyes to the fabric by heating the fabric at a temperature of between about 320 degrees Fahrenheit and 375 degrees Fahrenheit for between about 2 minutes and 10 minutes, wherein the finished dyed knitted fabric has a dry crocking index of at least 4.0 and a soft hand.

24. The garment of claim 23 wherein the fabric construction is knitted.

25. The garment of claim 23 wherein said synthetic-rich fabric contains at least 51% polyester.

26. The garment of claim 23 wherein the disperse dyes are applied by a process selected from the group of processes consisting of rotary screen printing, flat screen printing, and roller printing.

27. The garment of claim 23 wherein the finished dyed fabric has a wet crocking index of at least 4.0.

28. The garment of claim 23 wherein the colorfastness of the finished dyed fabric is 4.0 as measured by the AATCC 61-1996 test method.
